(19) United States
(12) Patent Application Publication
(10) Pub. No.: US 2007/0038370 A1
(43) Pub. Date: Feb. 15, 2007

(54) Global navigation system and method thereof

(76) Inventor: Chien-Yang Chang, Kuei San Hsiang (TW)

Correspondence Address: RABIN & Berdo, PC, 1101 14TH STREET, NW, SUITE 500, WASHINGTON, DC, 20005, US

(21) Appl. No.: 11/287,585

(22) Filed: Nov. 28, 2005

(30) Foreign Application Priority Data
Nov. 26, 2004 (TW) 93136640

(51) Int. Cl. G01C 21/00

(52) U.S. Cl. 701/211; 701/207

(57) ABSTRACT

A global navigation system that displays an electronic map for guiding a user to a destination contains: an input module to receive commands from the user; a plurality of navigation modules to initiate navigation functions in different countries and regions; a position detection module to detect the current position of the global navigation system; a region selecting module to direct to a specific country and region in response to the current position of the global navigation system and to select an electronic map that covers the current position of the global navigation system; and a display module to display the electronic map and related information.

### CROSS-REFERENCE TO RELATED APPLICATIONS

This non-provisional application claims priority under 35 U.S.C. § 119(a) on Patent Application No(s). 93136640 filed in Taiwan, R.O.C. on Nov. 26 2004, the entire contents of which are hereby incorporated by reference.

### BACKGROUND OF THE INVENTION

1. Field of Invention

The invention relates to a navigation system and the method thereof. In particular, the invention relates to a global navigation system and the method thereof.

2. Related Art

As traveling and electronic products become more popular, more consumers start to use electronic maps and satellite navigation systems, e.g. the global positioning system (GPS). Through the use of the system, a user can clearly know his or her location and the geography of the nearby region. Therefore, it is less likely for the user to get lost.

However, the currently used navigation systems are usually restricted to fixed areas. That is, they are mostly localized systems. The electronic maps only cover a limited region. For example, the electronic maps used in Taiwan normally cover the Taiwan area only.

However, while the consumers travel all over the world, they can only get very limited information from a conventional navigation system. Once going beyond the covered region, the user cannot get the required information. Therefore, a localized or region-limited navigation system can no longer satisfy consumers'needs. It is thus more desirable to have a global navigation system.

### SUMMARY OF THE INVENTION

In view of the foregoing, an objective of the invention is to provide a global navigation system and the method for the same so that the user can use local maps, wherever he or she is located, to learn about the current location and use the navigation function.

In other words, by switching the system to the local maps and navigation modules, even if the user is traveling among several countries, he or she will not get lost.

To achieve the above objectives, the invention provides a global navigation system that displays an electronic map for guiding a user to a destination. The global navigation system contains: an input module to receive commands from the user; a plurality of navigation modules to initiate navigation functions in different countries and regions; a position detection module to detect the current position of the global navigation system; a region selecting module to direct to a specific country and region in response to the current position, of the global navigation system and to select an electronic map that covers the current position of the global navigation system; and a display module to display the electronic map and related information.

The disclosed navigation method for the global navigation system includes: selecting a navigation module according to the current country and region; and initializing the navigation module to display an electronic map covering an appropriate range of the current position of the global navigation system.

### BRIEF DESCRIPTION OF THE DRAWINGS

The invention will become more fully understood from the detailed description given hereinbelow illustration only, and thus are not limitative of the present invention, and wherein:

FIG. 1 is a preferred embodiment of the disclosed global navigation system; and

FIG. 2 is a flowchart of the preferred embodiment of the method according to the invention.

### DETAILED DESCRIPTION OF THE INVENTION

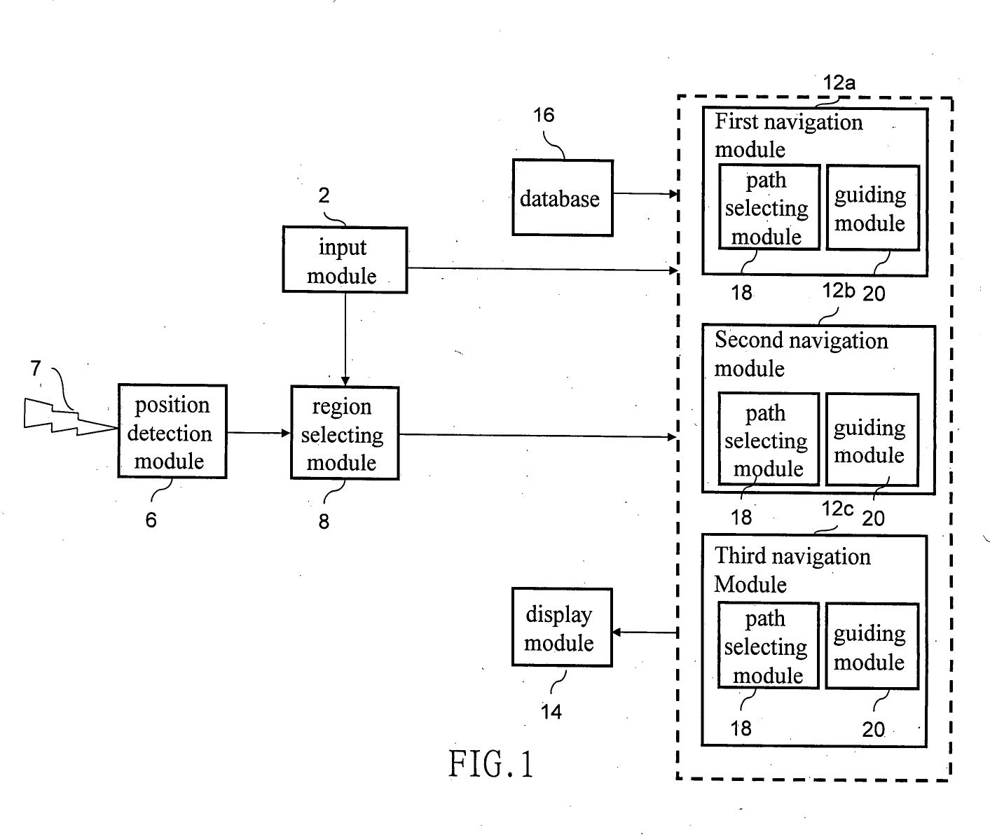

FIG. 1 shows a preferred embodiment of the disclosed global navigation system. It can display local electronic maps according to the location of the global navigation system to guide from current location to a destination. It should be explained that the invention can be installed in a vehicle or a portable electronic device, such as a personal digital assistant (PDA), a palm pilot, a cell phone, or a laptop computer. In addition to basic navigation functions, the system can further includes the functions of magnifying street crosses, speeding camera alarms, planning routes, schedules, networking, E-mailing, and cell phones.

The invention is characterized in that the provided global navigation system includes navigation software for all places. The system can switch among different navigation software for different regions according to the location of the global navigation system, so that the user can find any place along with related information from the electronic map displayed by the local navigation system.

The navigation system contains an input module 2, a position detection module 6, a region selecting module 8, a plurality of navigation modules for different regions 12a, 12b, 12c, a display module 14, and a database 16.

The input module 2 is used for the user to operate, and to select the desired functions. The input module 2 can be a remote control, a touch control panel, a keyboard, a mouse, or any other human-machine interface with similar functions. Therefore, by operating the input module, the user can switch among different navigation modules or maps for different regions, initialize navigation functions, select initial and destination point on the electronic map, and zoom in and out on the map.

The position detection module 6 is a receiver of the global positioning system (GPS) that receives a satellite signal 7 to locate the current position of the user, vehicle, other transportation tool, or the global navigation system itself. The relevant information is provided to the region selecting module 8 and a guiding module20 inside the selected navigation module (ex. 12a, 12b or 12c).

The region selecting module 8 determines the information of country and region of the current position according to the information provided by the position detection module 6 to select an electronic map that covers the current position of the global navigation system.

The method of selecting a corresponding navigation module is done as follows. The information provided by the position detection module 6 is compared with the data contained in a navigation module to select a compatible navigation module (ex. 12a, 12b or 12c). For example, the data used for comparison may be the coordinate data in an electronic map. Thus, the method provides a way of selecting a navigation module with an electronic map that has the right coordinates with the country and region of the current position.

The navigation module 12a, 12b, 12c of different regions can be provided and installed by different companies or a single company. For example, the first navigation module 12a, the second navigation module 12b, and the third navigation module 12a may have functions navigating in the U.S.A., Taiwan, and Japan.

Each of the navigation modules includes a path selecting module 18 and a guiding module 20.

The path selecting module 18 can extract required information from the database 16 according to the information provided by the region selecting module 8 or the position detection module 6 to select the electronic map with an appropriate range according to the information provided by the region selecting module 8. For example, it can select the electronic map of California in the U.S.A. or Taipei City in Taiwan. An image is then generated and sent to a display module 14 for display. Relevant information can be provided to the guiding module 20 too.

On the other hand, the path selecting module 18 can determine an initial point and a destination point according to the navigation instruction given from the input module 2 by the user and find a guiding path connecting the initial and destination point. After the guiding module 20 receives the information of the guiding path, the current position, and the electronic map, it can generate a resulting image and sends it to the display module 14 for display.

The display module 14 in this embodiment refers in particular to a liquid crystal display (LCD) for displaying images. Of course, other displays such as the cathode ray tube (CRT) and the plasma display can achieve the same function too.

The database 16 is a storage medium such as an optical storage medium (CD, DVD), a hard disk drive (HDD), a memory card, or other equivalent devices. It stores the data of electronic maps for different countries and regions. The data include terrain characters in a region, such as the roads, street names, crosses, attributes, two-dimensional (2D) coordinates, and other traffic related information. It should be noted that the database 16 here contains electronic maps of multiple regions and multiple countries. It covers at least the electronic maps of major countries in the world, such as the America, Japan, China, Australia, Britain, France, Italy, Germany, New Zealand, Russia, and Swiss.

Although we only depict one database 16 in the current embodiment, the electronic map data of different regions can be stored together or separately at various storage positions in practice. That is, the scope of the invention is not restricted by the example shown in this embodiment, but defined by the claims.

This embodiment uses only three navigation modules for the purposes of illustration. The actual number of navigation modules for different countries and regions in the world can be adjusted by the user or manufacturer according to needs.

In summary, the disclosed system can switch to an appropriate local electronic map to provide the required navigation functions according to the location of the global navigation system. The user is thus prevented from getting lost when traveling among countries.

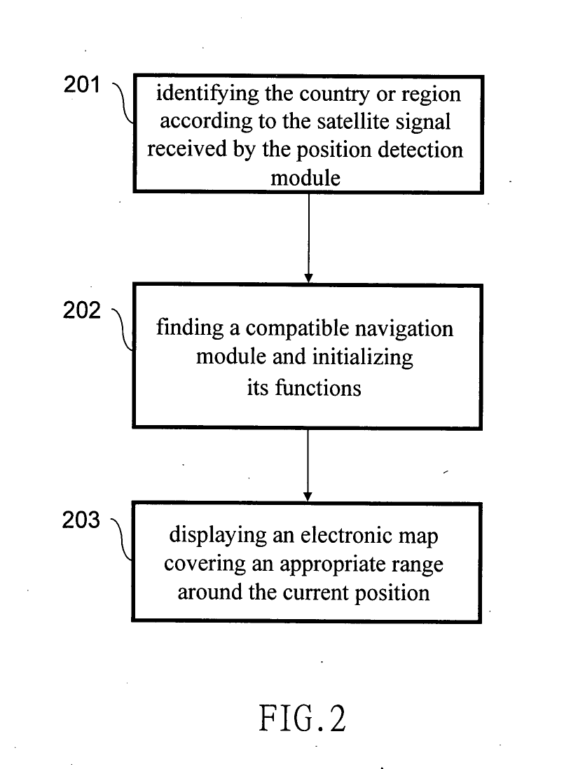

We use a preferred embodiment and the accompanying drawing to explain the disclosed method. As shown in FIG. 2, the navigation system locates the user, the vehicle or other transportation tool installed with the disclosed system, or the global navigation system itself (by identifying the country or region, for example) according to the satellite signal 7 received by the position detection module 6 (step 201). The region selecting module 8 takes the information provided by the position detection module 6 (e.g. the current position of the user or system) and compares it with data contained in each of the navigation modules, thereby finding a compatible navigation module (ex. 12a, 12b or 12c) and initializing its functions (step 202).

The function initialization can be as simple as displaying an electronic map covering an appropriate range around the current position (step 203). Once a navigation command is received, the system can provide the necessary navigation functions for a particular location.

In summary, the invention indeed can enable the user to use local electronic maps to find out his or her current position and therefore to make use of the navigation function, wherever the country or region is. That is, when a user is traveling among different countries, he or she will not get lost by switching the system to the local map and navigation function according to the invention.

Consequently, the invention is able to solve the problem of the current design of localized navigation systems that are restricted to fixed regions.

Certain variations would be apparent to those skilled in the art, which variations are considered within the spirit and scope of the claimed invention.

What is claimed is:

1. A global navigation system that displays an electronic map for guiding a user to a destination, comprising:
an input module for receiving a command from the user;
a plurality of navigation modules, each of which initializes the navigation function of a distinct country and region;
a position detection module for detecting the current position of the global navigation system;
a region selecting module for directing to a specific country and region in response to the current position of the global navigation system and selecting an electronic map that covers the current position of the global navigation system; and
a display module for displaying the electronic map and related information.

2. The global navigation system of claim 1, wherein the position detection module is a receiver of the global positioning system (GPS).

3. The global navigation system of claim 1, wherein the navigation module includes a path selecting module to select the electronic map with an appropriate range according to the information provided by the region selecting module.

4. The global navigation system of claim 3, wherein the path selecting module is used to determine an initial point and a destination point as soon as a navigation instruction is given to the input module so as to provide a guiding path connecting the initial and destination points.

5. The global navigation system of claim 4, wherein the navigation module contains a guiding module which is used to generate a resulting image shown on the display module after receiving the guiding path, the current position, and the electronic map.

6. The global navigation system of claim 1 further comprising a database for storing data of electronic maps of different countries and regions, wherein the data includes the terrain characteristics of a region.

7. The global navigation system of claim 1, wherein the terrain characteristics of a region comprises roads, street names, crosses, attributes, two-dimensional (2D) coordinates, and traffic information.

8. The global navigation system of claim 1, wherein the display module is a liquid crystal display (LCD).

9. The global navigation system of claim 1, wherein the input module is a remote control, a touch control panel, a keyboard, a mouse, or a human-machine interface.

10. A navigation method using a global navigation system that contains a plurality of navigation modules for different countries and regions, comprising the steps of:
selecting a navigation module according to the country and region of the current position; and
initializing the navigation module to display an electronic map covering an appropriate range of the current position.

11. The method of claim 10, wherein the step of initializing the navigation module to display an electronic map further comprises the steps of:
determining an initial point and a destination point as soon as a navigation instruction is given; and
generating a guiding path connecting the initial and destination points.

12. The method of claim 11, wherein the step of generating a guiding path further comprises the step of generating a resulting image for being displayed after receiving the data of the guiding path, the current position, and the electronic map.
